(19) United States
(12) Patent Application Publication
(10) Pub. No.: US 2007/0109971 A1
(43) Pub. Date: May 17, 2007

(54) Power line communication system

(76) Inventors: Shigeo Yoshida, Osaka (JP); Toru Yasukawa, Wakayama (JP)

Correspondence Address: WENDEROTH, LIND & PONACK L.L.P., 2033 K. STREET, NW, SUITE 800, WASHINGTON, DC, 20006, US

(21) Appl. No.: 10/573,773

(22) PCT Filed: Aug. 19, 2005
(86) PCT No.: PCT/JP05/15500

§ 371 Date: Mar. 28, 2006

(30) Foreign Application Priority Data
Aug. 24, 2004 (JP) 2004-243921

(51) Int. Cl. H04L 12/26; H04J 1/16

(52) U.S. Cl. 370/236; 370/252

(57) ABSTRACT

A communication control portion (11) performs most of communication processing performed by a communication apparatus (1). The communication control portion (11) also executes communication with another communication apparatus (1) using a communication parameter determined by a communication parameter determination portion (13). A transmission line estimation portion (12) measures characteristics of a transmission line (2) at a predetermined timing and regarding a predetermined section, and estimates the state of the transmission line (2). The communication parameter determination portion (13) newly generates an optimum communication parameter from a plurality of communication parameters obtained based on an estimation result obtained on the transmission line (2) by the transmission line estimation portion (12).

### TECHNICAL FIELD

The present invention relates to a communication apparatus and a transmission line estimation method, and more specifically to a communication apparatus for sending and receiving data based on the characteristics of a transmission line between communication apparatuses without lowering a throughput, and a transmission line estimation method for presuming and estimating the characteristics of the transmission line between the communication apparatuses with high precision.

### BACKGROUND ART

For a communication method by which a communication parameter, including a sub carrier and a modulation system to be used for sending and receiving data, is determined based on an estimation of the characteristics of a transmission line, it is important to highly precisely determine a communication parameter suitable for the characteristics of the transmission line at the time of sending. In the case of a communication system having attenuation characteristics heavily relying on the frequency (for example, power line carrier communication using a power line as a communication medium), a multi-carrier transmission line method which uses a sub carrier and a modulation system suitable for the characteristics of the transmission line is especially effective.

By a transmission line estimation method used for a conventional communication system, a transmission line estimation is performed periodically, or the characteristics of the transmission line are regarded as being deteriorated when the number of times that data is re-sent due to a communication error exceeds a predetermined value. Then, based on the result of the transmission line estimation, a new communication parameter is selected for sending and receiving data. See, for example, Japanese Laid-Open Patent Publication No. 2002-158675.

However, in a circumstance in which the characteristics of the transmission line periodically change, the reoccurs a situation where the communication parameter selected based on the result of the transmission line estimation does not suit the characteristics of the transmission line at the time of data sending, unless the timing of data sending is synchronized to the period by which the characteristics of the transmission line are changed. In such a case, the transmission line estimation does not necessarily provide the highest possible communication efficiency.

In order to solve this problem, the following technique is conventionally proposed. First, the period by which the characteristics of the transmission line are changed is synchronized with the frame period of the communication system and each period is divided into a plurality of sections. Next, a transmission line estimation is performed on each section. A tone map, obtained in the section having the highest communication efficiency and having the maximum PHY rate as a result of the transmission line estimation, is selected as the tone map to be used in the communication afterwards. A “tonemap” is information designating a communication parameter including sub carriers to be used and a modulation system for each of the sub carriers.

The tone map obtained in this manner is merely optimum for either one of the sections and is not necessarily information suitable for all the divided sections. In addition, a tone map having the maximum PHY rate designates a large number of sub carriers which are assigned to modulation systems having a high modulation factor, and has a large required receiving CNR (Carrier to Noise power Ratio). Therefore, such a tone map is low in noise resistance. As a result, when the communication parameter does not match the characteristics of the transmission line at the time of data sending, a tone map having the maximum PHY rate is likely to cause errors, resulting in a high re-sending ratio. Accordingly, communication by a tone map having the maximum PHY rate does not necessarily have the maximum MAC rate. The MAC rate is a throughput seen from an upper layer.

### DISCLOSURE OF THE INVENTION

Accordingly, the present invention has an object of providing a communication apparatus for newly generating an optimum tone map based on a plurality of tone maps, each of which is obtained by a transmission line estimation of each section, and thus realizing stable, high speed transmission even in a circumstance in which the characteristics of the transmission line periodically change because of periodical changes of noise and impedance, and a transmission line estimation method performed by such a communication apparatus.

The present invention is directed to a communication apparatus for communicating with another communication apparatus via a transmission line in which the characteristics of the transmission line periodically change. In order to achieve the above object, the communication apparatus according to the present invention comprises a communication control portion, a transmission line estimation portion and a communication parameter determination portion.

The transmission line estimation portion divides a period by which the characteristics of the transmission line are changed into n number of sections (n is an integer equal to or greater than 2) and estimates the characteristics of the transmission line regarding each of the n number of sections. The communication parameter determination portion acquires n number of communication parameters optimum for the respective n number of sections in accordance with an estimation result obtained by the transmission line estimation portion, and determines one communication parameter which is optimum for all the n number of sections based on the n number of communication parameters.

Preferably, the communication parameter determination portion obtains a total sum of each of the n number of communication parameters, the total sum being obtained by multiplication using an applicability coefficient, which is defined in accordance with communication quality when the respective communication parameter is applied to the other sections, and adding the multiplication results; and determines the communication parameter having the maximum total sum as the one communication parameter optimum for all the n number of sections. Preferably, the applicability coefficient is the number of sections having a message error ratio equal to or less than a predetermined value when each of the n number of communication parameters is applied to the other sections, a rank of a PHY rate which is obtained from the n number of communication parameters, or estimated in accordance with a result of dividing each of the n number of communication parameters into a plurality of groups having different communication frequencies and comparing the groups having the same communication frequency in the n number of communication parameters.

Preferably, the communication parameter determination portion may synthesize the n number of communication parameters of the n number of sections in accordance with an applicability coefficient, which is defined in accordance with communication quality when each of the n number of communication parameters is applied to the other sections, and thus generate n number of new communication parameters; and determine one communication parameter which is optimum for all the n number of sections based on the n number of new communication parameters. In this case, the communication parameter determination portion may obtain a total value obtained by multiplying each of the new n number of communication parameters by the applicability coefficient, and determine the communication parameter having the maximum total value as the one communication parameter optimum for all the n number of sections.

Specifically, the communication parameter determination portion places the n number of communication parameters into ranks in accordance with the highest to the lowest PHY rate; performs synthesis processing of synthesizing the communication parameter placed at an i'th rank (i=1 through n) with the communication parameter placed at an (i−1)th or higher rank and thus generates a new communication parameter placed at the i'th rank; obtains a total value by multiplying each of then number of new communication parameters by the number of sections in which the respective communication parameter is effective; and determines the new communication parameter having the maximum total value as the one communication parameter optimum for all the n number of sections.

In the case where the communication parameter includes at least information providing a plurality of usable sub carriers and a modulation factor of each of the plurality of sub carriers, the synthesis processing compares a modulation factor of the communication parameter placed at the i'th rank and a modulation factor of the communication parameter placed at the (i−1)th or higher rank regarding each of the plurality of sub carriers, and generates a new communication parameter placed at the i'th rank in which the modulation factor of the communication parameter placed at the i'th rank has been updated into the lowest modulation factor. The number of sections in which the communication parameter placed at the i'th rank is effective is typically i.

The processing performed by each element of the above-described communication apparatus can be understood as a transmission line estimation method including a series of processing steps. This method is provided in the form of a program causing a computer to execute the series of processing steps. Such a program may be introduced into the computer in the form of being stored in a computer-readable recording medium. The functional blocks included in the above-described communication apparatus may be implemented as an LSI as an integrated circuit.

As described above, according to the present invention, an optimum tone map is newly generated from tone maps obtained as a result of a transmission line estimation performed on a plurality of sections. Therefore, a tone map capable of sending and receiving data at a higher throughput than a tone map directly obtained from the transmission line estimation can be obtained. This improves the communication efficiency.

### BRIEF DESCRIPTION OF THE DRAWINGS

FIG. 1 shows an exemplary structure of a communication network system using communication apparatuses according to one embodiment of the present invention.

FIG. 2 shows an example of timing of the transmission line estimation performed by the communication apparatus according to one embodiment of the present invention.

FIG. 3 shows a communication sequence of the procedure of the transmission line estimation performed by the communication apparatus according to one embodiment of the present invention.

FIG. 4 shows the relationship between the transmission line estimation section and the tone map.

FIG. 5 shows estimation particulars of each tone map.

FIG. 6 shows a tone map determination method according to a first example.

FIG. 7 shows a tone map determination method according to a second example.

FIG. 8A and FIG. 8B show a method for creating a synthesized tone map according to a third example.

FIG. 9 shows estimation particulars of each synthesized tone map.

FIG. 10 shows an exemplary network system in which a communication apparatus according to the present invention is applied to high speed power line transmission.

### BEST MODE FOR CARRYING OUT THE INVENTION

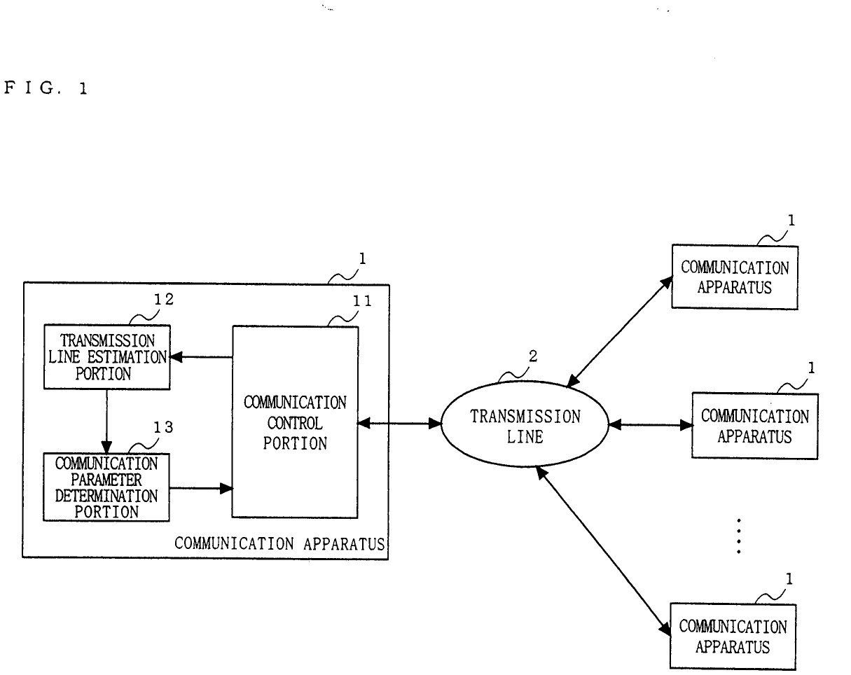

FIG. 1 shows an exemplary structure of a communication network system using communication apparatuses 1 according to one embodiment of the present invention. In FIG. 1, the communication network system according to the present invention includes a plurality of communication apparatuses 1 connected via a transmission line 2. The transmission line 2 may be wireless or wired.

Each communication apparatus 1 includes a communication control portion 11, a transmission line estimation portion 12, and a communication parameter determination portion 13. The communication control portion 11 performs most of the communication processing performed by the communication apparatus 1. Basically, the communication control portion 11 executes communication with the other communication apparatuses 1 using a communication parameter determined by the communication parameter determination portion 13. The transmission line estimation portion 12 measures the characteristics of the transmission line 2 at a predetermined timing and regarding a predetermined section, and estimates the state of the transmission line 2. The communication parameter determination portion 13 determines an optimum parameter based on a plurality of communication parameters obtained from the estimation result on the transmission line 2 performed by the transmission line estimation portion 12.

Hereinafter, an exemplary estimation method performed on the characteristics of the transmission line by the communication apparatus 1 having the above-described structure will be described.

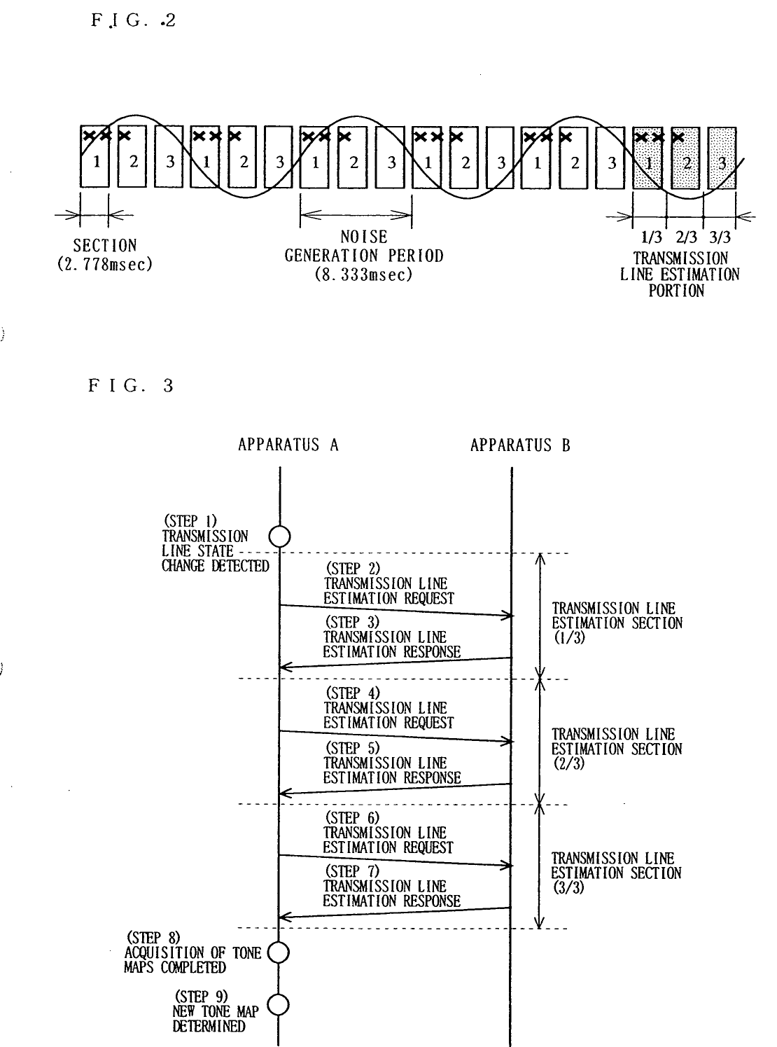

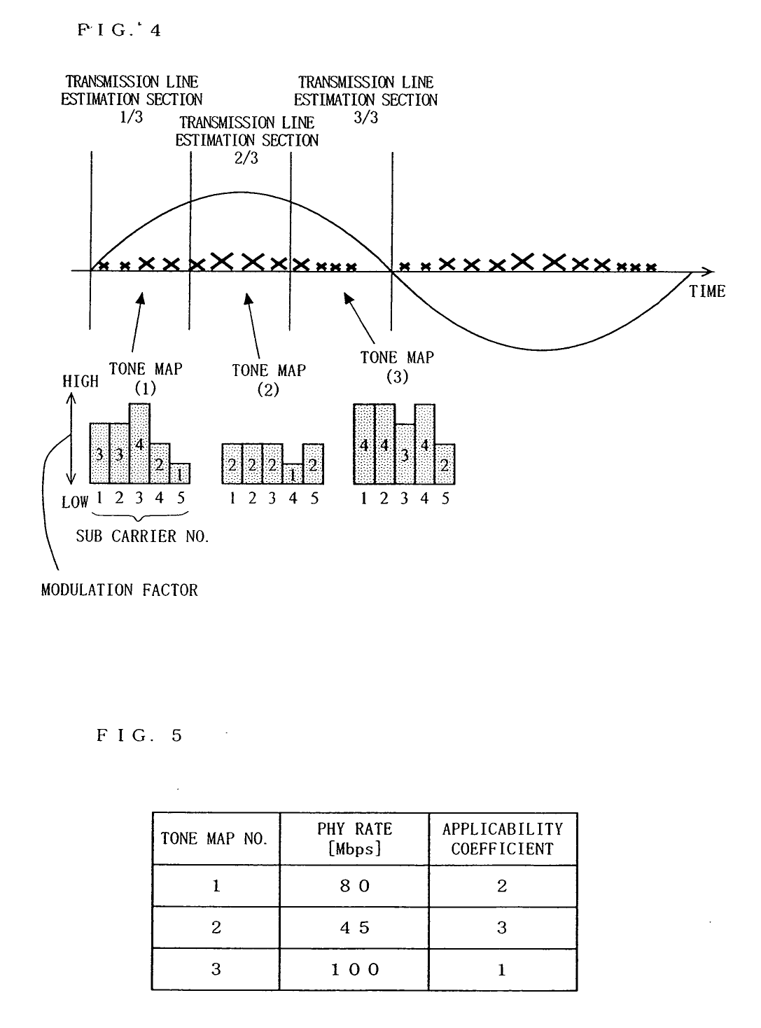

FIG. 2 shows an example of timing of the transmission line estimation performed by the communication apparatus 1. FIG. 3 shows an example of procedure of the transmission line estimation performed by the communication apparatus 1.

In this embodiment, as shown in FIG. 2, noise having a constant pattern (“x” in FIG. 2) is generated at a constant interval in the transmission line 2 in the communication network system; i.e., a period L by which the characteristics of the transmission line are changed is the certain interval. In this situation, the communication control portion 11 of each communication apparatus 1 of the communication network system divides the period L into a plurality of sections (three sections in the example of FIG. 2), and performs the transmission line estimation on each section.

There maybe a case where the period by which the noise pattern is changed on the power line is equal to a half period of the commercial power source (50 Hz or 60 Hz) because of the influence of the power source circuit of home-use electronic devices or the like connected to the power line. Accordingly, when designing a communication network system using the powerline, it is necessary to consider the characteristics of the transmission line synchronized with the half period of the commercial power source (see the sine wave in FIG. 2).

Referring to FIG. 3, the procedure of the transmission line estimation performed by the communication apparatus 1 will be described in detail.

When a communication apparatus 1 (hereinafter, referred to as an “apparatus A”) is initially started after being turned on or when the apparatus A detects a change in the characteristics of the transmission line (step 1), the apparatus A requests a communication apparatus 1 (hereinafter, referred to as an “apparatus B”), with which the apparatus A communicates, to estimate a transmission line estimation section 1/3 (indicated by “1” in the hatched area in FIG. 2) (step 2). The apparatus B sends a response to the request for the transmission line estimation (step 3). The transmission line estimation is performed, for example, as follows.

First, the transmission line estimation request and a predetermined series of estimation items are sent from the apparatus A to the apparatus B. Based on the series of estimation items, the apparatus B calculates a receiving CNR (Carrier to Noise power Ratio). Next, the apparatus B creates a tone map designating a communication parameter including sub carriers to be used and a modulation system of each of the sub carriers in accordance with the calculated receiving CNR. Then, the apparatus B sends a transmission line estimation result including the tone map to the apparatus A as a response to the request. Such a multi-carrier transmission system is merely an example, and other systems, for example, a spectrum diffusion system may be used. In the above description, information on the receiving CNR is used, but other information may be used.

In the same manner, the apparatus A measures characteristics of the other transmission line estimation sections (steps 4 through 7). In the example of FIG. 2, characteristics of a transmission line estimation section 2/3 (indicated by “2” in the hatched area in FIG. 2) and a transmission line estimation section 3/3 (indicated by “3” in the hatched area in FIG. 2) are measured. By this processing, the apparatus A completes the transmission line estimation on, i.e., completes the acquisition of a tone map of, all the three transmission line estimation sections (step 8). Based on the plurality of tone maps acquired, the apparatus A determines an optimum tone map to be used for the communication using one of the techniques described in the examples below (step 9).

### FIRST EXAMPLE

It is assumed that by the processing performed in steps 1 through 8, three tone maps shown in FIG. 4 are acquired. Tone maps (1) through (3) are respectively acquired from the transmission line estimation sections 1/3 through 3/3. Each tone map includes information on Nos. of sub carriers to be used and on a modulation factor of each of the sub carriers.

For example, the tone map (1) in FIG. 4 indicates that the sub carriers No. 1 and No. 2 are each assigned a modulation factor of “3”, the sub carrier No. 3 is assigned a modulation factor of “4”, the sub carrier No. 4 is assigned a modulation factor of “2”, and the sub carrier No. 5 is assigned a modulation factor of “1”. In this example, the number of sub carriers is five for the sake of simplicity, but there is no limitation on the number of sub carriers. As the modulation factor is higher, an amount of data transmittable by a corresponding sub carrier is larger. As the number of sub carriers having a high modulation factor is larger, the PHY rate (communication quality or communication performance) is higher. In the example of FIG. 4, the transmission line estimation sections 1/3, 2/3 and 3/3 have a PHY rate of 80 Mbps, 45 Mbps and 100 Mbps, respectively, as shown in FIG. 5.

First, the communication parameter determination portion 13 obtains an applicability coefficient to be assigned to each of the tone maps (1) through (3), based on how applicable the tone map of each section is to the other sections. Whether a tone map is applicable to the other sections or not can be determined based on whether an error occurs in the message when a tone map of one section is applied to the other sections; or when the error occurs, whether the error rate is no more than a predetermined threshold value. In actuality, however, the transmission line estimation is not performed using a tone map of one section for the other sections. Therefore, the applicability coefficient is typically assigned in the order of the highest to the lowest PHY rate. The PHY rate indicates the communication quality of each tone map. In this example, as shown in FIG. 5, the applicability coefficient of the tone map (3) is “1”, the applicability coefficient of the tone map (1) is “2”, and the applicability coefficient of the tone map (2) is “3”.

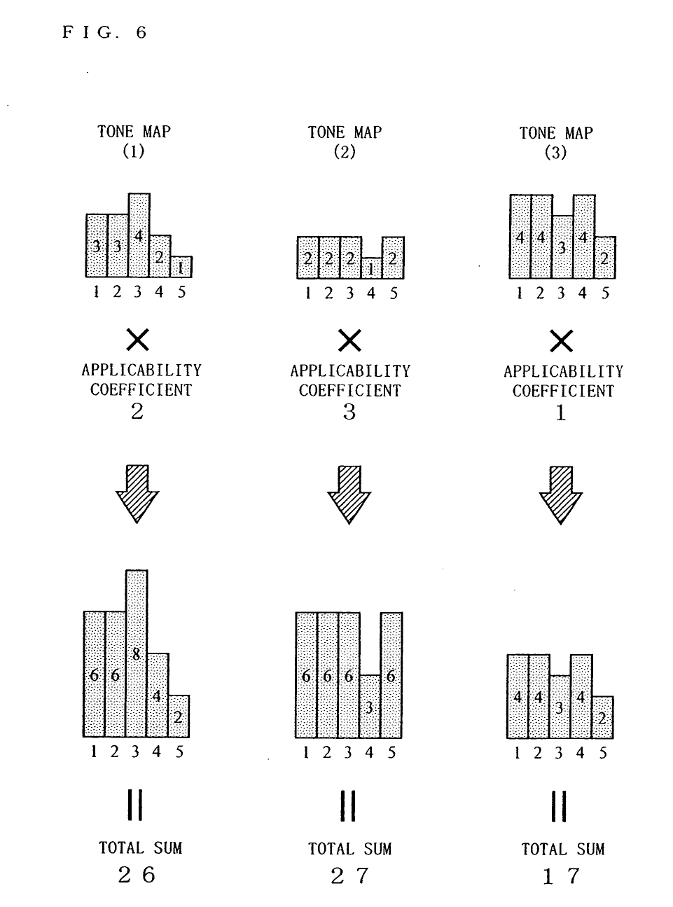

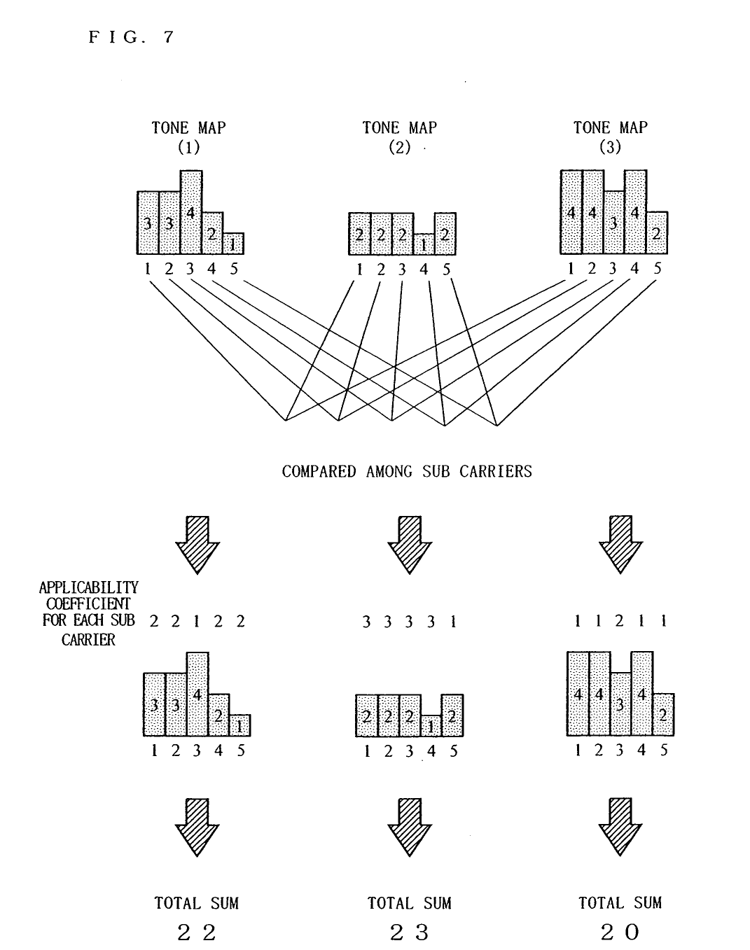

Next, the communication parameter determination portion 13 calculates a total sum of each of the tone maps (1) through (3). The total sum is obtained by multiplying the modulation factor of each of the sub carriers No. 1 through No. 5 by the applicability coefficient, and adding the multiplication results. As shown in FIG. 6, the total sum of the tone map (1) is 26 (=(3+3+4+2+1)×2), the total sum of the tone map (2) is 27 (=(2+2+2+1+2)×3), and the total sum of the tone map (3) is 17 (=(4+4+3+4+2)×1).

Finally, the communication parameter determination portion 13 compares the obtained total sums and finds a tone map having the maximum total sum (the tone map (2) in this example) It is expected that when the tone map (2) having the maximum total sum is used, the maximum average MAC throughput is obtained throughout the communication. Therefore, the tone map (2) is determined as an optimum tone map to be used for the communication.

### SECOND EXAMPLE

Like in the first example, it is assumed that by the processing performed in steps 1 through 8, three tone maps shown in FIG. 4 are acquired.

First, the communication parameter determination portion 13 compares the modulation factors of the sub carriers having the same No. (each of No. 1 through No. 5) in the tone maps (1) through (3), and obtains the applicability coefficient to be assigned to each sub carrier in the order of the highest to the lowest modulation factor. More specifically, as shown in FIG. 7, the comparison is performed among the modulation factor “3” of the sub carrier No. 1 of the tone map (1), the modulation factor “2” of the sub carrier No. 1 of the tone map (2), and the modulation factor “4” of the subcarrier No. 1 of the tone map (3). As a result, regarding the sub carrier No. 1, the applicability coefficient is “1” for the tone map (3), “2” for the tone map (1), and “3” for the tone map (2).

In the same manner, regarding the sub carrier No. 2, the applicability coefficient is “1” for the tone map (3), “2” for the tone map (1), and “3” for the tone map (2). Regarding the sub carrier No. 3, the applicability coefficient is “1” for the tone map (1), “2” for the tone map (3), and “3” for the tone map (2). Regarding the sub carrier No. 4, the applicability coefficient is “1” for the tone map (3), “2” for the tone map (1), and “3” for the tone map (2). Regarding the sub carrier No. 5, the applicability coefficient is “1” for the tone map (3), “1” for the tone map (2), and “2” for the tone map (1).

Next, the communication parameter determination portion 13 calculates a total sum of each of the tone maps (1) through (3). The total sum is obtained by multiplying the modulation factor of each of the sub carriers No. 1 through No. 5 by the applicability coefficient, and adding the multiplication results. The total sum of the tone map (1) is 22(=3×2+3×2+4×1+2×2+1×2). The total sum of the tone map (2) is 23 (=2×3+2×3+2×3+1×3+2×1). The total sum of the tone map (3) is 20 (=4×1+4×1+3×2+4×1+2×1). The communication parameter determination portion 13 compares the obtained total sums and finds a tone map having the maximum total sum.

In the above example, the modulation factors of the sub carriers having the same No. in different tone maps are compared. Alternatively, each tone map maybe divided into groups of arbitrary communication frequencies and the comparison maybe performed among the groups of the same communication frequency in different tone maps.

In the above example, the applicability coefficient is obtained based on the order of the modulation factor. Alternatively, the applicability coefficient maybe obtained based on a comparison result on the receiving CNRs in the frequencies of the sub carriers.

### THIRD EXAMPLE

Like in the first example, it is assumed that by the processing performed in steps 1 through 8, three tone maps shown in FIG. 4 are acquired.

First, the communication parameter determination portion 13 places the tone maps (1) through (3) into ranks based on how applicable the tone map of each section is to the other sections. The rank has the same meaning as that of the applicability coefficient described in the first example.

Next, the communication parameter determination portion 13 compares the modulation factors of the sub carriers having the same No. (each of No. 1 through No. 5) in each tone map (each of (1) through (3)) and all the tone maps placed at a higher rank than the each tone map. Thus, the communication parameter determination portion 13 creates a new tone map including sub carriers No. 1 through No. 5 each having the lowest modulation factor. This method will be described specifically.

The tone map (3) is placed at the highest rank. Therefore, the comparison on the modulation factor is not performed. In this case, the tone map (3) is used as a synthesized tone map (3) as it is.

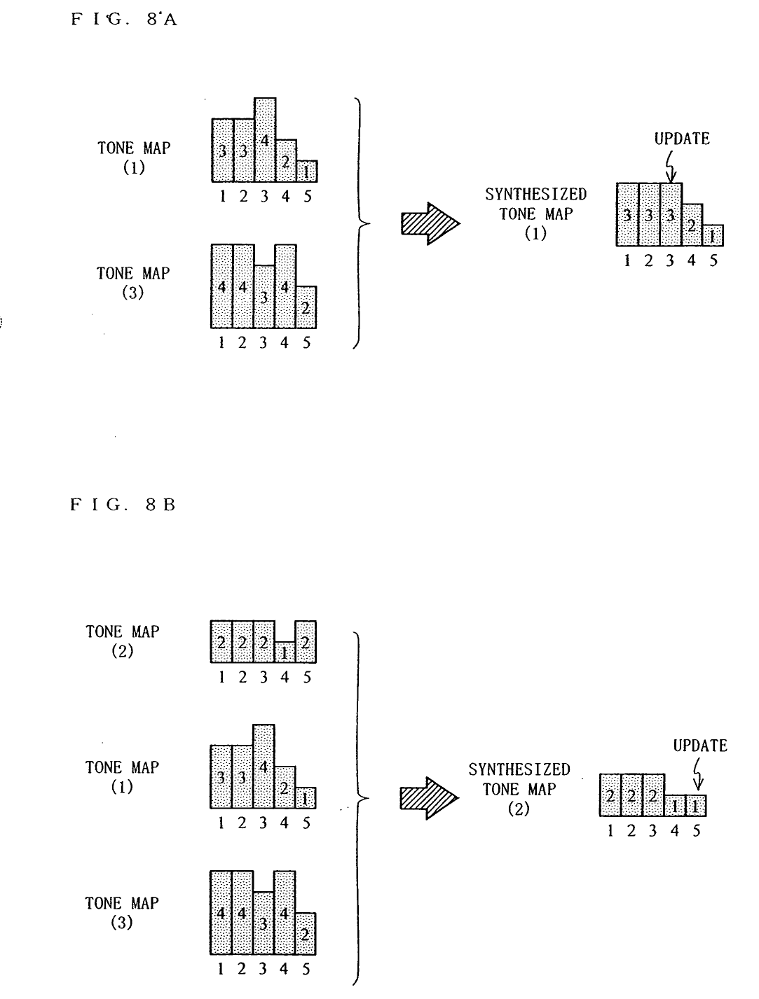

The tone map (1) is placed at the second highest rank. Therefore, the comparison on modulation factor is performed between the tone map (1) and the tone map (3) placed at the highest rank. As shown in FIG. 8A, between the tone map (1) and the tone map (3), the modulation factors of the subcarriers No. 1, No. 2, No. 4 and No. 5 are lower in the tone map (1), and the modulation factor of the sub carrier No. 3 is lower in the tone map (3) In this case, a synthesized tone map (1) is newly created in which the modulation factor of only the sub carrier No. 3 of the tone map (1) has been updated to the modulation factor of the sub carrier No. 3 of the tone map (3).

The tone map (2) is placed at the lowest rank. Therefore, the comparison on the modulation factor is performed between the tone map (2) and each of the tone map (1) which is placed at the second highest rank and the tone map (3) which is placed at the highest rank. As shown in FIG. 8B, the tone map (2) and the tone map (1) are compared in accordance with the above-described rule. As a result, a synthesized tone map (2) is newly created in which the modulation factor of only the sub carrier No. 5 of the tone map (2) has been updated to the modulation factor of the sub carrier No. 5 of the tone map (1). Next, the synthesized tone map (2) and the tone map (3) are compared. The modulation factors of all the sub carriers are lower in the synthesized tone map (2) than in the tone map (3). Therefore, the synthesized tone map (2) is not updated.

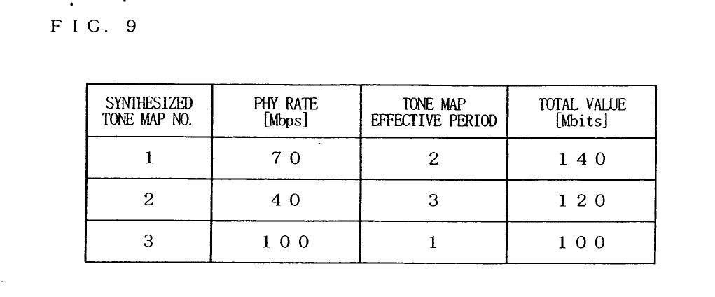

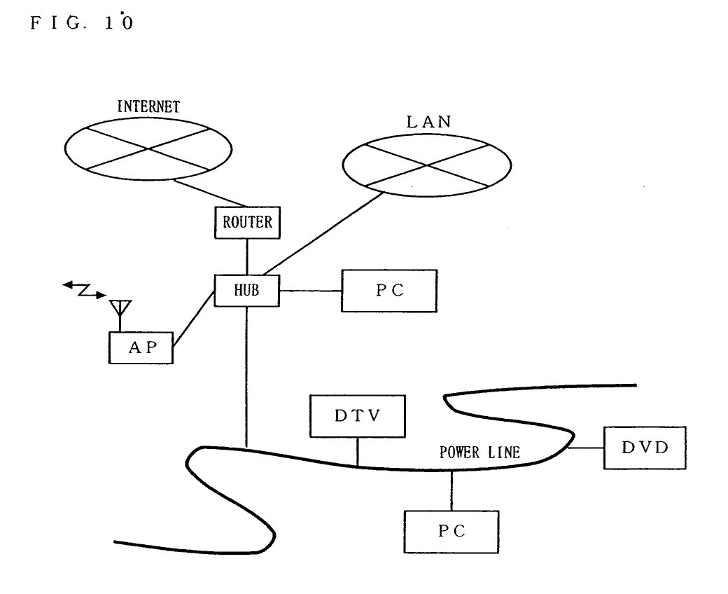

As shown in FIG. 9, the PHY rates of the synthesized tone maps (1) through (3) created by the above-described comparison processing are 70 Mbps, 40 Mbps and 100 Mbps, respectively. Where a tone map is used as a communication parameter, a time period which has a bit error rate equal to or lower than a predetermined value and is considered to have a sufficiently low packet error rate with respect to data transmission is defined as a tone map effective period. In this example, it is considered that the tone map effective period of the synthesized tone map (3) having the highest PHY rate is the transmission line estimation section 3/3, the tone map effective period of the synthesized tone map (1) having the second highest PHY rate includes two transmission line estimation sections 1/3 and 3/3, and the tone map effective period of the synthesized tone map (2) having the lowest PHY rate includes three transmission line estimation sections 1/3, 2/3 and 3/3. This is based on the fact that a tone map having a higher PHY rate has a higher required signal to noise ratio and is lower in noise resistance.

The communication parameter determination portion 13 multiplies the PHY rate by the tone map effective period regarding each of the synthesized tone maps (1) through (3) to obtain a total value. The results of the multiplication are as follows:

The total value of the synthesized tone map (1) is 140 Mbits (=70 Mbps×2 sections).

The total value of the synthesized tone map (2) is 120 Mbits (=40 Mbps×3 sections).

The total value of the synthesized tone map (3) is 100 Mbits (=100 Mbps×1 section).

As a result, it is expected that when the synthesized tone map (1) having the maximum total value is used, the maximum average MAC throughput is obtained throughout the communication. Therefore, the tone map (1) is determined as an optimum tone map to be used for the communication.

As described above, with the communication apparatus and the transmission line estimation method according to one embodiment of the present invention, an optimum tone map is newly created from tone maps obtained by a transmission line estimation of a plurality of sections. Therefore, a tone map capable of sending and receiving data at a higher throughput than a tone map directly obtained from the transmission line estimation can be obtained. This improves the communication efficiency. The applicability coefficient for obtaining a total sum of each tone map, and the tone map effective period for obtaining a total value of each synthesized tone map, may be weighted in accordance with the rank of the PHY rate.

The transmission line estimation method performed by the communication apparatus described above is realized by parsing and processing by a CPU of a predetermined program stored in a memory device (a ROM, a RAM, a hard disc etc.) and capable of executing the above-described processing procedure. In this case, the program data may be introduced into the memory device via a recording medium such as a CD-ROM, a flexible disc or the like, or may be directly executed from the recording medium.

The functional blocks of a communication apparatus according to the present invention are typically implemented as an LSI as an integrated circuit (also referred to an IC, a system LSI, a super LSI, an ultra LSI etc. in accordance with the degree of integration). Each functional block may be incorporated into one chip; or a part of, or the entirety of, the functional blocks may be incorporated into one chip.

The integrated circuit may be provided as a specialized circuit or a multi-purpose processor instead of an LSI. Alternatively, an FPGA (Field Programmable Gate Array) which is programmable after LSI production, or a reconfigurable processor in which the connection or setting of circuit cells in the LSI is reconfigurable, may be used.

When the development of the semiconductor technology and generation of other technologies derived therefrom produce integration techniques replacing the LSI, the functional blocks may be integrated using such techniques. Application of biotechnology is possible as an example.

Hereinafter, an example in which the present invention is applied to an actual network system will be described. FIG. 10 shows an exemplary network system in which the present invention is applied to high speed power line transmission. In the example of FIG. 10, the IEEE1394 interface, the USB interface or the like of multi-media devices such as a personal computer, a DVD recorder, a digital TV, a home server system and the like is connected to the power line via a module having the functions provided by the present invention. Thus, a network system can be constructed for transmitting digital data such as multi-media data or the like at high speed using the power line as a medium. In this system, the power line already installed in the houses, offices and the like can be used as a network line without newly installing a network cable as required by the conventional wired LAN. Therefore, this system is highly applicable in terms of cost and ease of installation.

The above-described network system is an example in which existing devices are used for power line transmission by inserting an adaptor for converting a signal interface of an existing multi-media device into a power line transmission interface. In the future, multi-media devices will have the functions provided by the present invention built therein, which will allow data transmission between the multi-media devices via a power source cable thereof. In this case, the adaptor, the IEEE1394 cable, the USB cable are not necessary and thus the wiring is simplified. Since connection to the Internet via a router and connection to a wireless/wired LAN via a hub or the like are realized, a LAN system can be extended using a high speed power transmission system using the present invention. With the power line transmission system, communication data is transmitted via a power line. Therefore, the problem which occurs in wireless LANs such that radio wave is intercepted and data is leaked does not occur. Thus, the power line transmission system is effective for security, for example, data protection. The data transmitted through the power line is protected by, for example, the IP sec of the IP protocol, encryption of the contents, and other DRM systems.

By implementing QoS functions including a copy right protection function by encryption of the contents and the effects provided by the present invention (improvement in the throughput, band allocation capable of flexibly responding to an increase in the re-sending ratio and a change in traffic), high quality transmission of AV contents using a power line is made possible.

### INDUSTRIAL APPLICABILITY

A communication apparatus and a transmission line estimation method according to the present invention are applicable to a communication system and the like in which the characteristics of a transmission line periodically change, and are especially effective in the case where, for example, it is wished to presume and estimate the characteristics of the transmission line with high precision and send and receive data at a high throughput.

1. A communication apparatus for communicating with another communication apparatus via a transmission line in which characteristics of the transmission line periodically change, the communication apparatus comprising:
a transmission line estimation portion for dividing a period by which the characteristics of the transmission line are changed into n number of sections (n is an integer equal to or greater than 2) and estimating the characteristics of the transmission line regarding each of the n number of sections; and
a communication parameter determination portion for acquiring n number of communication parameters optimum for the respective n number of sections in accordance with an estimation result obtained by the transmission line estimation portion, and determining one communication parameter which is optimum for all the n number of sections based on the n number of communication parameters.

2. A communication apparatus according to claim 1, wherein the communication parameter determination portion obtains a total sum of each of the n number of communication parameters, the total sum being obtained by multiplication using an applicability coefficient, which is defined in accordance with communication quality when the respective communication parameter is applied to the other sections, and adding the multiplication results; and determines the communication parameter having the maximum total sum as the one communication parameter optimum for all the n number of sections.

3. A communication apparatus according to claim 2, wherein the applicability coefficient is the number of sections having a message error ratio equal to or less than a predetermined value when each of the n number of communication parameters is applied to the other sections.

4. A communication apparatus according to claim 2, wherein the applicability coefficient is a rank of a PHY rate which is obtained from the n number of communication parameters.

5. A communication apparatus according to claim 2, wherein the applicability coefficient is estimated in accordance with a result of dividing each of the n number of communication parameters into a plurality of groups having different communication frequencies and comparing the groups having the same communication frequency in the n number of communication parameters.

6. A communication apparatus according to claim 1, wherein the communication parameter determination portion synthesizes the n number of communication parameters of the n number of sections in accordance with an applicability coefficient, which is defined in accordance with communication quality when each of the n number of communication parameters is applied to the other sections, and thus generates n number of new communication parameters; and determines one communication parameter which is optimum for all the n number of sections based on the n number of new communication parameters.

7. A communication apparatus according to claim 6, wherein the communication parameter determination portion obtains a total value obtained by multiplying each of the new n number of communication parameters by the applicability coefficient, and determines the communication parameter having the maximum total value as the one communication parameter optimum for all the n number of sections.

8. A communication apparatus according to claim 7, wherein the communication parameter determination portion:
places the n number of communication parameters into ranks in accordance with the highest to the lowest PHY rate;
performs synthesis processing of synthesizing the communication parameter placed at an i'th rank (i=1 through n) with the communication parameter placed at an (i−1)th or higher rank and thus generates a new communication parameter placed at the i'th rank;
obtains a total value by multiplying each of the n number of new communication parameters by the number of sections in which the respective communication parameter is effective; and
determines the new communication parameter having the maximum total value as the one communication parameter optimum for all the n number of sections.

9. A communication apparatus according to claim 8, wherein:
the communication parameter includes at least information providing a plurality of usable subcarriers and a modulation factor of each of the plurality of sub carriers; and
the synthesis processing compares a modulation factor of the communication parameter placed at the i'th rank and a modulation factor of the communication parameter placed at the (i−1)th or higher rank regarding each of the plurality of sub carriers, and generates a new communication parameter placed at the i'th rank in which the modulation factor of the communication parameter placed at the i'th rank has been updated into the lowest modulation factor.

10. A communication line estimation method executed by a communication apparatus for communicating with another communication apparatus via a transmission line in which characteristics of the transmission line periodically change, the method comprising:
dividing a period by which the characteristics of the transmission line are changed into n number of sections (n is an integer equal to or greater than 2) and estimating the characteristics of the transmission line regarding each of the n number of sections; and
acquiring n number of communication parameters optimum for the respective n number of sections in accordance with an estimation result obtained by the estimating; and
determining one communication parameter which is optimum for all the n number of sections based on the n number of communication parameters.

11. A program for causing a communication apparatus, for communicating with another communication apparatus via a transmission line in which characteristics of the transmission line periodically change, to execute communication line estimation, the program comprising:
dividing a period by which the characteristics of the transmission line are changed into n number of sections (n is an integer equal to or greater than 2) and estimating the characteristics of the transmission line regarding each of the n number of sections; and
acquiring n number of communication parameters optimum for the respective n number of sections in accordance with an estimation result obtained by the estimating; and
determining one communication parameter which is optimum for all the n number of sections based on the n number of communication parameters.

12. An integrated circuit usable for a communication apparatus for communicating with another communication apparatus via a transmission line in which characteristics of the transmission line periodically change, the integrated circuit including circuits integrated and acting as:
a transmission line estimation portion for dividing a period by which the characteristics of the transmission line are changed into n number of sections (n is an integer equal to or greater than 2) and estimating the characteristics of the transmission line regarding each of the n number of sections; and
a communication parameter determination portion for acquiring n number of communication parameters optimum for the respective n number of sections in accordance with an estimation result obtained by the transmission line estimation portion, and determining one communication parameter which is optimum for all the n number of sections based on the n number of communication parameters.
